(19) United States
(12) Patent Application Publication
(10) Pub. No.: US 2008/0231765 A1
(43) Pub. Date: Sep. 25, 2008

(54) Electro-optical device

(75) Inventor: Hirosada Horiguchi, Minowa-machi (JP)

Correspondence Address: ADVANTEDGE LAW GROUP, LLC, 3301 NORTH UNIVERSITY AVE., SUITE 200, PROVO, UT, 84604, US

(73) Assignee: Seiko Epson Corporation, Tokyo (JP)

(21) Appl. No.: 12/075,952

(22) Filed: Mar. 15, 2008

(30) Foreign Application Priority Data
Mar. 22, 2007 (JP) 2007-074134

(51) Int. Cl. G02F 1/13

(52) U.S. Cl. 349/4; 349/110; 349/2

(57) ABSTRACT

The disclosure is directed to an electro-optical device. In one example, a plurality of pixels each has a pixel pitch and a light transmissible region. A light shielding unit is configured to restrict the light transmissible region of each of the pixels to a region a size of 1/M (M being an integer) of the pixel pitch in each of a horizontal direction and a vertical direction for each of the pixels.

### CROSS-REFERENCE

The present application claims priority from Japanese Patent Application No. 2007-074134 filed on Mar. 22, 2007, which is hereby incorporated by reference in its entirety.

### BACKGROUND

Photolithography machines used for photo printing may include a digital photolithography machine which performs exposure by emitting light to photographic paper on the basis of image data has been developed. With such digital photolithography machines, there is equipment which uses an electro-optical device such as a liquid crystal panel and equipment which uses a laser.

The digital photolithography machine performs exposure on the basis of digitized image data. Since various image processing of the image data, such as brightness adjustment of an image can be easily carried out by a computer, the workability of various operations from the image processing of the imaged picture to the exposure, using the digital photolithography machine may be improved.

With the equipment using a laser, the exposure is performed by scanning an object with laser light on the basis of the image data. Therefore, when trying to raise resolution, the total exposure time is likely to be extended. Conversely, when trying to decrease the total exposure time, it is necessary to lower the resolution or to shorten the exposure time per unit area, which leads to a sacrifice of gradation. Accordingly, the throughput and the resolution, or the throughput and the gradation, result in a tradeoff relationship with the laser system.

On the other hand, with the digital photolithography machine using a liquid crystal panel, the liquid crystal panel is driven on the basis of an image signal and the exposure is performed in a manner such that light which has been emitted from a light source and has passed through out the liquid crystal panel changes into image light and the image light is made incident onto photographic paper. Accordingly, in the digital photolithography machine using a liquid crystal panel, it is possible to perform plane sequential exposure and to set relatively long exposure time per unit area. For this reason, the digital photolithography machine using a liquid crystal panel is superior in expression of gradation and in obtaining a picture with high resolution.

Furthermore, in recent years, publication WO-2004-107733-A1 discloses the technique of raising resolution by performing exposure while shifting the relative position of the liquid crystal panel to photographic paper in the direction of a surface. In the technique disclosed in WO-2004-107733-A1, the photographic paper is exposed to image light from pixels of a liquid crystal panel via a micro lens. Accordingly, the size of a light converging portion on the photographic paper for each pixel may be decreased by controlling the focus of the micro lens. Further, the exposure of the entire surface to the image light may be achieved by performing exposure while shifting the liquid crystal panel horizontally and vertically according to the size of the light converging portion. For example, if the size of the light converging portion is set to ¼ (½ in each of a horizontal direction and a vertical direction) of the size of the pixel on the photographic paper, the entire surface of the photographic paper will be exposed by performing four times of exposure, while shifting the liquid crystal panel by the half of a pixel size for every exposure. In the division exposure using such a pixel shifting method, printing with resolution of four times of the number of pixels of the liquid crystal panel may be attained by performing exposure on the basis of the image data corresponding to the positions of light converging portions.

As mentioned above, the technique in WO-2004-107733-A1 controls the size of the light converging portion on the photographic paper by an optical system and carries out the division exposure using a pixel shifting method. This, however, requires very high accuracy for an optical system. There are problems in that it is difficult in practice to precisely control the size of the light converging portion with precision of 1/M (M being an integer) of the size of a pixel on the photographic paper, and in that the optical system is set up in a manner such that the converging portions overlap each other.

For this reason, the overlap portion may undergo exposures based on two different pictures in the above-mentioned device. Accordingly, for at least these reasons, the device may experience problems with image quality deterioration.

### SUMMARY

In certain embodiments, an electro-optical device includes a plurality of pixels which are arranged in a matrix form so as to correspond to intersections of a plurality of scan lines and a plurality of data lines disposed on a substrate and which change light transmissivity in response to a signal supplied via the scan lines and the data lines, and a light shielding unit which restricts a light transmissible region of each pixel to a region a size of which in each of a horizontal direction and a vertical direction is 1/M (M is an integer) of a pixel pitch.

With such a structure, the aperture ratio of each pixel is restricted to 1/M (M is an integer) of 100% by the light shielding unit. Therefore, if the exposure to the photosensitive material is carried out using transmitted light, an area corresponding to 1/M (M is an integer) of an exposure region corresponding to each pixel will be exposed by one exposure. For example, it is possible to accomplish the exposure to the entire area of the photosensitive material by repeatedly performing the division exposure using a pixel shifting method. As a result, the size of one exposure using the pixel shifting method may be specified by the light shielding unit, and thus it is possible to more accurately specify the size of an exposure region.

According to certain embodiments, an electro-optical device converts light from a light source into image light on the basis of an image signal and exposes a photosensitive material to the image light via an optical system. The electro-optical device includes a plurality of pixels which are arranged in a matrix form so as to correspond to intersections of a plurality of scan lines and a plurality of data lines disposed on a substrate and which change light transmissivity in response to a signal supplied via the scan lines and data lines, and a light shielding unit which restricts a light transmissible region of each pixel in both a horizontal direction and a vertical direction thereof so that a size of each exposure region on the photosensitive material which is irradiated with light which has passed through the light transmissible region of each pixel and the optical system is 1/M (M is an integer) of a size corresponding to the pixel pitch on the photosensitive material, which is calculated based on the optical system.

With such a structure, the exposure is performed so that the photosensitive material is exposed to the image light via a predetermined optical system. The light shielding unit enables an area corresponding to 1/M (M is an integer) of an exposure region corresponding to a pixel to be exposed by one exposure. For example, the exposure to the entire area of the photosensitive material can be accomplished by repeatedly performing the division exposure using a pixel shifting method. The size of one exposure based on the pixel shifting is determined by the light shielding unit, and thus it is possible to more precisely determine the size of the exposure region.

According to certain embodiments, an electro-optical device converts light from a light source into image light and exposes a photosensitive material to the image light via an optical system. The electro-optical device includes a plurality of pixels which are arranged in a matrix form at intersections of a plurality of scan lines and a plurality of data lines disposed on a substrate and which changes light transmissivity in response to a signal supplied via the scan lines and the data lines, and a light shielding unit which restricts a light transmissible region of each pixel to a region a size of which is 1/L (L is an integer) of a pixel pitch in each of a horizontal direction and a vertical direction so that a horizontal size and a vertical size of each exposure region on the photosensitive material, which corresponds to a pixel, become 1M (M is an integer) of a horizontal size and 1/N (N is an integer) of a vertical size of an exposure region, respectively, which correspond to the pixel pitch on the photosensitive material.

In such a structure, the exposure is carried out by irradiating the surface of the photosensitive material with the light via a predetermined optical system. The light shielding unit restricts an aperture ratio of each pixel to 1/M (M is an integer) of 100%. Accordingly, an area corresponding to 1/M (M is an integer) of an exposure region which corresponds to a pixel is exposed by one exposure. For example, the entire region of the photosensitive material can be exposed by repeatedly performing the division exposure using a pixel shifting method. The size of one exposure using the pixel shifting method can be more precisely determined because the size is determined by the light shielding unit.

In the electro-optical device, the light shielding unit may restrict the light transmissible region of each pixel to a size of 1/M (M is an integer) of a pixel pitch of each of a horizontal direction and a vertical direction by an amount of spread of the image light attributed to a predetermined optical system.

With such a structure, the light shielding unit sets up an aperture ratio lower than 1/M (M is an integer) of 100% by an amount of spread of the image light which is attributable to the predetermined optical system. Accordingly, it is possible to more accurately control the size of the division exposure which uses the pixel shifting method by restricting the light transmissible region. Also, it is not necessary to employ an optical system which may be difficult to control, and it is possible to more accurately control the size of the exposure.

In the electro-optical device, the pixel may be constituted by an electro-optical material interposed between the substrate and an opposite substrate which faces the substrate, and the light shielding unit may be constituted by a light shielding film formed on either the substrate and/or the opposite substrate.

With such a structure, it is possible to accomplish the precise exposure control using a liquid crystal device.

### BRIEF DESCRIPTION OF THE DRAWINGS

Various embodiments are described with reference to the accompanying drawings, wherein like numbers reference like elements.

FIG. 1 is a plan view illustrating elements of an electro-optical device according to one embodiment.

FIG. 2 is a schematic view illustrating a digital exposure apparatus incorporating the electro-optical device of FIG. 1.

FIG. 3 is a plan view viewed from the opposite substrate for illustrating a substrate and various elements formed on the substrate.

FIG. 4 is a sectional view taken along line IV-IV of FIG. 3 substrate.

FIG. 5 is a circuit diagram illustrating various elements in a plurality of pixels which form a pixel region of a liquid crystal device.

FIG. 6 is a sectional view illustrating a structure of a pixel of a liquid crystal device in more detail.

FIGS. 7A to 7D are diagrams illustrating the state of exposure on photosensitive material.

FIG. 8 is a plan view illustrating certain elements of an electro-optical device according to another embodiment.

### DESCRIPTION OF EXEMPLARY EMBODIMENTS

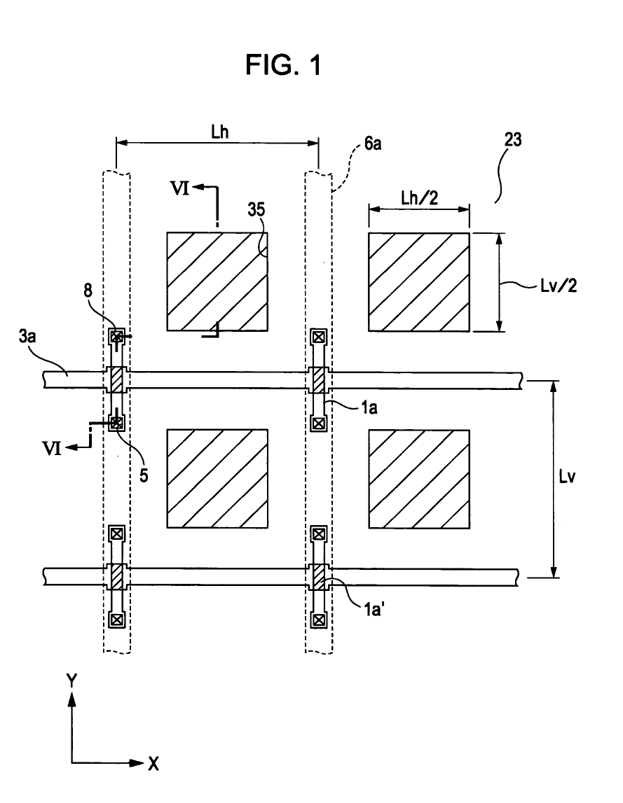

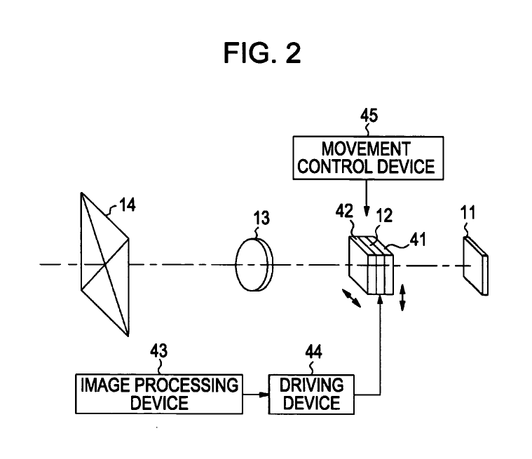

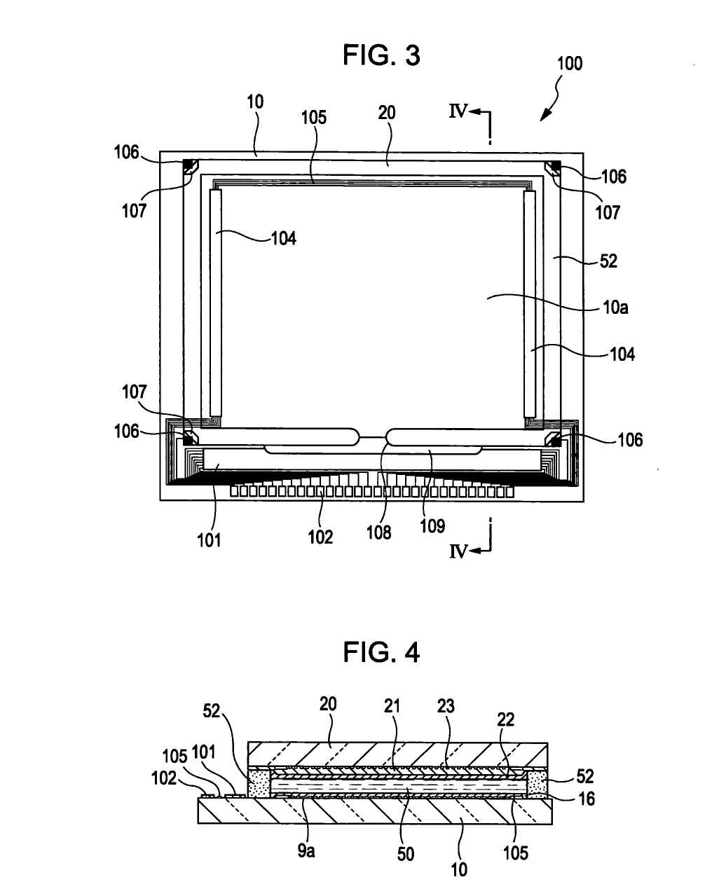

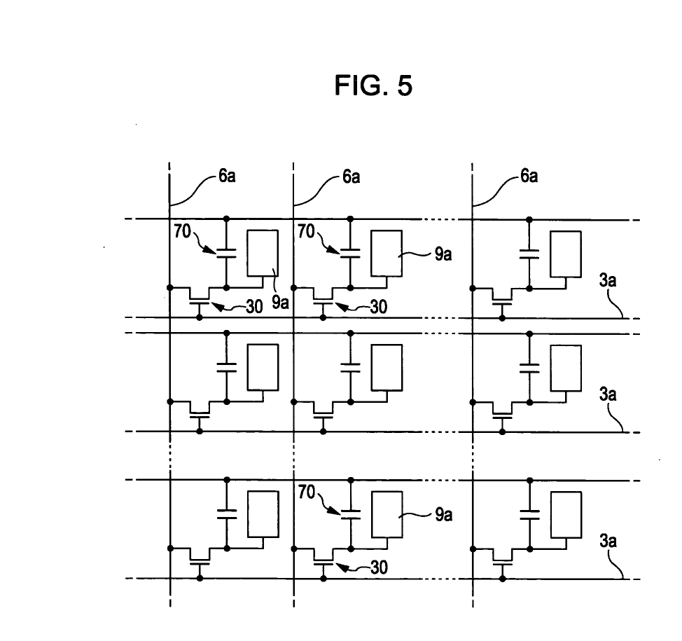

Hereinafter, certain embodiments will be explained in detail with reference to the accompanying drawings. FIG. 1 is a plan view illustrating some main elements of an electro-optical device according to a first embodiment. FIG. 2 is a schematic view illustrating a digital exposure apparatus incorporating the electro-optical device of FIG. 1. FIG. 3 is a plan view viewed from the opposite substrate side, which illustrates an substrate and various elements formed on the substrate, which constitute a liquid crystal device which is an exemplary embodiment of the electro-optical device of FIG. 1. FIG. 4 is a sectional view taken along line IV-IV in FIG. 3 for illustrating the liquid crystal device after completion of an assembly process in which the substrate and the opposite substrate are joined with each other and liquid crystals are sealed between the substrate and the opposite substrate. FIG. 5 is an equivalent circuit diagram illustrating various elements in a plurality of pixels which form a pixel region of the liquid crystal device and various wirings. FIG. 6 is a cross-sectional view illustrating the structure of a pixel of the liquid crystal device in additional detail. Layers and members in the above-mentioned drawings are depicted in different scales in order to show the layers and members in readily ascertainable size.

Turning first to FIGS. 3 and 4, the liquid crystal device encloses liquid crystals 50 between a substrate 10 using a quartz substrate, a glass substrate, or a silicon substrate, and an opposite substrate 20 which is disposed so as to face the substrate 10 and which uses a glass substrate or a quartz substrate. The substrate 10 and the opposite substrate 20 facing each other are joined with each other by a sealing member 52.

The substrate 10 is provided with pixel electrodes (ITO) 9a which constitute pixels and are arranged in a matrix form. The opposite substrate 20 is provided with an opposite electrode (ITO) 21 at the entire region thereof. An aligning film 16 which has undergone an aligning process is formed on the pixel electrodes 9a disposed on the substrate 10. An aligning film 22 which has undergone an aligning process is formed on the opposite electrode 21 formed over the entire area of the opposite substrate 20.

FIG. 5 illustrates equivalent circuits of elements on the substrate 10 which constitute a pixel. As shown in FIG. 5, a plurality of scan lines 3a and a plurality of data lines 6a are wired so as to intersect each other in a pixel region, and the pixel electrodes 9a are arranged in a matrix form in regions demarcated by the scan lines 3a and the data lines 6a. TFTs 30 are disposed so as to correspond to intersections of the scan lines 3a and the data lines 6a and the TFTs 30 are connected to the pixel electrodes 9a, respectively.

The TFTs 30 are turned on with an ON signal from the scan lines 3a and thus an image signal supplied to the data line 6a is supplied to the pixel electrodes 9a. A voltage between the pixel electrode 9a and the opposite electrode 21 disposed on the opposite substrate 20 is applied to the liquid crystals 50. Moreover, storage capacitors 70 are disposed in parallel with the pixel electrodes 9a, and it is possible to maintain the voltage of the pixel electrodes 9a for a period of time that is longer than a period of source voltage application time. As a result of the storage capacitors 70, the voltage maintenance characteristic may be improved and it is possible to perform image display at higher contrast.

The plural pixel electrodes 9a are disposed in a matrix form on the substrate 10, and the data lines 6a and the scan lines 3a are disposed along the edges of the pixel electrodes 9a in a longitudinal direction and a lateral direction. As described later in detail, the data lines 6a may be formed of an aluminum film, and the scan lines 3a may be formed of a conductive polysilicon film. Further, the scan lines 3a may be formed so as to face channel regions 1a′ which will be described later. At the intersection between the scan lines 3a and the data lines 6a, gate electrodes connected with the scan lines 3a and the channel regions 1a′ are disposed so as to face each other and constitute the TFTs 30 serving as pixel switching elements.

The sealing member 52 which seals the liquid crystals inside thereof by being disposed along the edges of the opposite substrate 20 is formed between the substrate 10 and the opposite substrate 20. The sealing member 52 is arranged so that the outline form thereof is almost the same as the opposite substrate 20, and the sealing member 52 joins the substrate 10 and the opposite substrate 20 to each other. The sealing member 52 is not present at a portion of one side of the substrate 10 in order to form a liquid crystal injection hole 108 through which the liquid crystals 50 are injected. The liquid crystals 50 are injected into the gap between the substrate 10 and the opposite substrate 20 which are joined to each other through the liquid crystal injection hole 108. After the injection of the liquid crystals 50, the liquid crystal injection hole 108 may be closed by a sealing agent 109.

A data line drive circuit 101 and a mounting terminal 102 are disposed in a region disposed outside the sealing member 52 of the substrate 10 along one side of the substrate 10. Scan line drive circuits 104 are disposed so as to extend along two sides of the substrate 10, which are adjacent to the above-mentioned one side. A plurality of wirings 105 for connecting the scan line drive circuits 104 disposed in both sides of a screen display region to each other is disposed along the remaining one side of the substrate 10. At the four corners of the outside of the sealing member 52, up-and-down electrical interconnection members 106 are arranged. A lower end of the up-and-down electrical interconnection member 106 contacts an up-and-down electrical interconnection terminal 107, and an upper end thereof contacts the common electrode 21, so that the up-and-down electrical interconnection members 106 connects both electrically. Thereby, the wirings 105 and the common electrode 21 formed outside the pixel region are connected to each other electrically.

In certain embodiments, a light shielding film 23 is formed on the opposite substrate 20. In the electro-optical device, an image display region is divided into light transmissible regions (also referred to herein as opening regions) and light shielding regions, and the TFTs are installed in the light shielding regions so that elements, such as TFTs and wirings, may not be reflected.

The light shielding film 23 is formed so as to cover a large portion of the entire area of the pixel electrodes 9a as well as formed on the data lines 6a and the scan lines 3a in a plan view in order to limit an aperture ratio to a pixel pitch. For example, as it will be described later, the light shielding film 23 is formed in a manner such that the size of an opening becomes 1/M (M being an integer) of the pixel pitch. Further, the pixel electrodes 9a may be formed only at regions facing the openings and formed around the regions.

FIG. 6 is a schematic sectional view illustrating one pixel of an exemplary liquid crystal device. FIG. 6 is a view taken along line VI-VI of FIG. 1.

The TFTs 30 are formed in the substrate 10, such as a glass substrate or a quartz substrate. Each of the TFTs 30 is constituted by a semiconductor layer in which a channel region 1a′, a source region 1d, and a drain region 1e are formed, and the scan line 3a which serves as a gate and is disposed on the semiconductor layer with an insulation layer 2 interposed therebetween.

A first interlayer insulation film 4 is laminated on the TFTs 30, and the data lines 6a are laminated on the first interlayer insulation film 4. The data lines 6a are electrically connected to the source regions 1d through contact holes 5 which penetrate the first interlayer insulation film 4.

A second interlayer insulation film 7 is formed on the first interlayer insulation film 4 and the data lines 6a. The pixel electrodes 9a are formed on the second interlayer insulation film 7. The pixel electrodes 9a are electrically connected to the drain regions 1e, respectively through contact holes 8 which penetrate the second interlayer insulation film 7 and the first interlayer insulation film 4. The aligning film 16, which may be made of a polymer resin based on polyimide, is laminated on the pixel electrodes 9a and the second interlayer insulation film 7 and the aligning film 16 undergoes an aligning process for aligning orientations of liquid crystals in a predetermined direction.

When the ON signal is supplied to the scan lines 3a (gate electrodes), channel regions 1a′ will be in an electrical connection state, and thus the source regions 1d and the drain regions 1e are connected with each other. As a result, the image signal supplied to the data lines 6a is applied to the pixel electrodes 9a.

The light shielding film 23 may be formed in the opposite substrate 20 in the regions which face some regions of the TFT array substrate, at which the data lines 6a, the scan lines 3a, and the TFTs 30 are formed, and in the regions which face some pixel electrodes 9a. The light shielding film 23 may be formed over the opposite substrate 20 except for regions of the openings 35. The light shielding film 23 not only prevents light, from the opposite substrate 20 side, from entering the channel regions 1a′, the source regions 1d, and the drain regions 1e of the TFTs 30 but also defines an opening region of each pixel.

The opposite electrode (common electrode) 21 may be formed on the light shielding film 23 and continuously formed over substrate 20. The aligning film 22, which may be made of a polymer resin based on polyimide, is laminated on the opposite electrode 21, the aligning film 22 having undergone a rubbing processing carried out in a predetermined direction.

The liquid crystals 50 are sealed between the substrate 10 and the opposite substrate 20. The TFTs 30 may write the image signals supplied from the data lines 6a at predetermined timing into the pixel electrodes 9a. According to the potential difference between the pixel electrode 9a in which the image signal is written and the opposite electrode 21, the alignment state of molecules of the liquid crystal 50 changes. As a result, light is modulated and a gradation display is enabled.

In addition, a conductor layer and a dielectric layer which constitute the storage capacitors 70 of FIG. 5 and which are not illustrated in FIG. 6 are also formed on the substrate 10. In accordance with certain embodiments, the aperture ratio is set up to be sufficiently small by the light shielding film 23, and it is possible to form the storage capacitors 70 in the light shielding regions in a sufficiently large area.

In FIG. 1, channel regions 1a′ of the TFTs 30 are formed at respective intersections of the data lines 6a (each extending in a Y direction) and the scan lines 3a (each extending in an X direction). FIG. 1 shows only four pixels arranged two by two in a vertical direction and a horizontal direction, respectively. Typically, in a liquid crystal device, regions other than the data lines 6a and the scan lines 3a, i.e. regions surrounded by the data lines 6a and the scan lines 3a, become opening regions. However, in the liquid crystal device according to certain embodiments, the opening regions 35 are provided at only a portion of the regions that can be set as openings. In the example shown in FIG. 1, a pixel pitch of the horizontal direction is set as Lh and a pixel pitch of the vertical direction is set as Lv. The size of each opening 35 is set by the horizontal pixel pitch Lh/2 and the vertical pixel pitch Lv/2.

As illustrated in FIG. 1, the opening regions 35 are formed at approximately center portions of the regions which are defined by the data lines 6a and the scan lines 3a. However, the opening regions 35 may be disposed at any position in the corresponding regions.

Moreover, although the example of FIG. 1 illustrates the size of the opening region 35 as one half (½) of the pixel pitch, it is possible to configure the size of the opening region 35 at a size of 1/M (M being an integer) of the pixel pitch. The regions other than the opening regions 35 are structured in a manner such that the light which progresses from the opposite substrate 20 does not reach the substrate 10 due to the light shielding film 23.

Furthermore, although the embodiment illustrated in FIG. 6 depicts the light shielding film 23 disposed on the opposite substrate 20, the light shielding film that controls an aperture ratio may be disposed on the substrate 10 and/or the opposite substrate 20. For example, in certain embodiments, the opposite substrate 20 may be provided with a light shielding film which prevents the light from entering the TFTs 30 and the substrate 10 may be provided with a light shielding film which controls the aperture ratio.

FIG. 2 illustrates a digital exposure apparatus including a liquid crystal device. In FIG. 2, the digital exposure apparatus, such as a digital photolithography machine, includes a liquid crystal device 12 which is an electro-optical device and a baking lens 13 which are arranged between a light source 11 (e.g., a light source device) and photosensitive material 14, such as photographic paper. Polarizing plates 41 and 42 may be disposed on both sides of the liquid crystal device 12. The polarizing plates 41 and 42 permit light having a predetermined polarization axis to pass therethrough. The polarization axis of light incident to the liquid crystal device 12 is determined by the polarizing plate 41, and the polarization axis of light exiting the liquid crystal device 12 is determined by the polarizing plate 42. In the liquid crystal device 12, the image light exiting from the polarizing plate 42 may be adjusted by changing the polarization axis of passage light according to image data.

The light source 11 may comprise a light emitting diode (LED) array. The LED array serving as the light source 11 may be equipped with a plurality of LEDs which emit colored light having a plurality of wavelength bands having different light emitting bands. For example, the LED array as the light source 11 may emit red (R), green (G), and blue (B) light. The baking lens 13 arranged on an optical path extending from the light source 11 to the photosensitive material 14 is a lens for imaging an image of the incidence light to the photosensitive material 14.

In certain embodiments, the electro-optical device 12 may be replaced with a filter which switches lamps in a plane-sequential manner.

An image processing device 43 supplies the image data for exposure to a driving device 44 after performing predetermined image processing, if necessary. In certain embodiments, the image-processing device 43 outputs the image data according to a resolution magnification which is a ratio of a pixel pitch and the size of the opening region 35 to the number of pixels of the liquid crystal device 12. For example, in embodiment illustrated in FIG. 1, a ratio of the pixel pitch and the size of the opening region 35 is 2:1 in each of a horizontal direction and a vertical direction. Accordingly, in the case in which the resolution magnification in the horizontal direction and the vertical direction is 2 and the number of pixels of the liquid crystal device 12 is 640 (in the horizontal direction)×840 (in the vertical direction), the image data of the resolution of 640×2 pixels (horizontal direction) pixels and 480×2 pixels (vertical direction) is output.

The driving device 44 drives the liquid crystal device 12 by supplying the image data to the liquid crystal device 12. In this case, the driving device 44 outputs the image data per one pixel from the image-processing device 43 for every pixel by one exposure. If a spread of the picture of an optical system is disregarded, when the image light from the liquid crystal device 12 is made incident onto the photosensitive material 14, the photosensitive material 14 is exposed by an area which is a size of 1/M (M being a resolution magnification) of an exposure area which corresponds to the size of each pixel of the liquid crystal device 12 by one exposure.

The movement control device 45 is configured to move the liquid crystal device 12 according to the resolution magnification of the liquid crystal device 12 for every exposure. The liquid crystal device 12 is configured to be freely movable horizontally and vertically in a plane which is parallel with a light incidence plane and a light exit plane by a piezoelectric element and an XY stage (not illustrated). The driving device 44 outputs image data corresponding to a next one pixel from the image processing device 43 in a subsequent exposure for every pixel of the liquid crystal device 12. The movement of the liquid crystal device 12 and the exposure are repeated a number of times, which number is a value obtained by calculating (a horizontal resolution magnification by a vertical resolution magnification), so that the exposure to the entire area of the photosensitive material 14 is achieved.

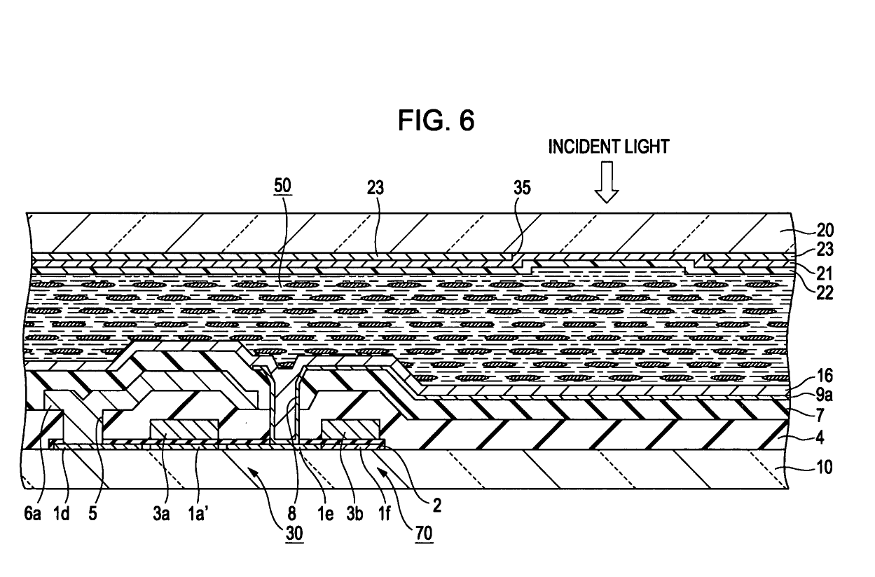

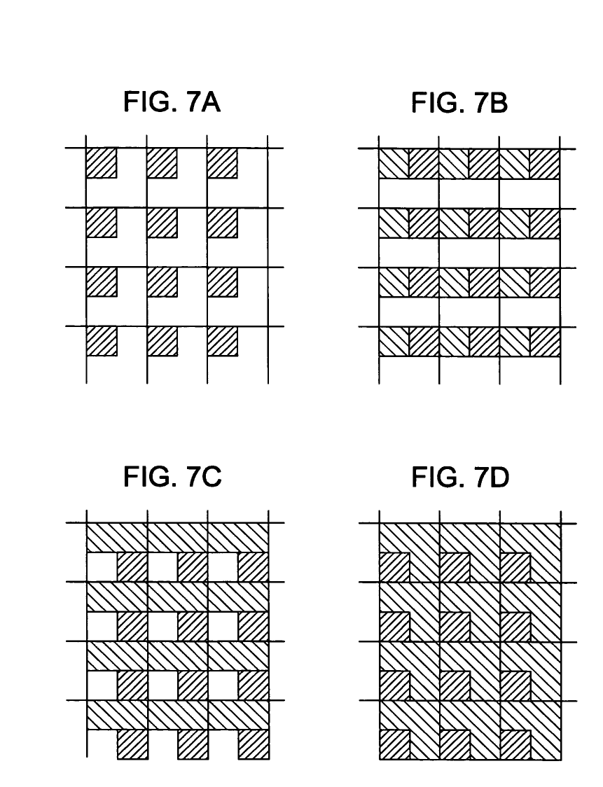

Next, the operation in accordance with certain embodiments will be described with reference to FIGS. 7A to 7D. FIGS. 7A to 7D are diagrams illustrating the state of exposure on the photosensitive material 14. FIGS. 7A to 7D show the situation of a first exposure through a fourth exposure. FIGS. 7A to 7D correspond to FIG. 1 and show examples in which a resolution magnification in each of a horizontal direction and a vertical direction is set at 2. In addition, in color exposure, although an exposure using red R, green G, and blue B light emitted from the light source 11 is performed, explanation about switching of such R, G, and B light is omitted for simplification of the description herein.

Certain embodiments are suitable for an exposure which uses a so-called pixel shifting method which shifts relative positions of the photosensitive material and the liquid crystal device by moving at least one of the liquid crystal device which converts the light from the light source to the image light and the photosensitive material in a plane which is perpendicular to an optical axis. Hereinafter, the exposure using the pixel shifting will be described.

The image-processing device 43 outputs the image data to the driving device 44, after performing the image processing with respect to a picture to be exposed if necessary. The picture from the image processing device 43 has resolution which is a value obtained by calculating (the number of pixels of the liquid crystal device 12×the resolution magnification of the horizontal direction×the resolution magnification of the vertical direction). Hereinafter, an example will be described in which the resolution magnification in each of the horizontal direction and the vertical direction is a value equal to 2.

The driving device 44 drives the liquid crystal device 12 by applying the image data, which is input, to the liquid crystal device 12. In this case, the driving device 44 outputs data corresponding to one pixel of the picture from the image processing device 43 for every pixel of the liquid crystal device 12 in every exposure. That is, the driving device 44 drives the liquid crystal device 12 by applying the image data corresponding to a region to be exposed by the division exposure using the pixel shifting method to the liquid crystal device 12. For example, the driving device 44 is made to supply data corresponding to ¼ pixel on the right side and ¼ pixel on the left side of each pixel to the liquid crystal device 12 in a first exposure.

The liquid crystal device 12 is driven on the basis of the image data from the driving device 44, and it changes the transmissivity of the light from the light source 11. Thus, the image light based on the image data exits from the polarizing plate 42 on the light exit side of the liquid crystal device 12. The image light is irradiated on the photosensitive material 14 via the baking lens 13 and thus the exposure is carried out.

FIG. 7A shows the exposure state in some regions on the photosensitive material 14 in this case. A region hatched with slashes which incline down to the left of FIG. 7A show the region where exposure has been performed. The regions surrounded by the horizontal lines and the vertical lines in FIGS. 7A to 7D are exposure regions corresponding to pixels of the liquid crystal equipment 12. As described above, the horizontal size and the vertical size of the opening region 35 of the liquid crystal device 12 are half (½) of the pixel pitch in the horizontal direction and half (½) of the pixel pitch in the vertical direction, respectively. Accordingly, only one fourth (¼) of each exposure region (horizontal ½, vertical ½) on the photosensitive material, which is surrounded by a frame in FIGS. 7A to 7D, is exposed by one exposure.

Next, the movement control device 45 moves the liquid crystal device 12 in a plane which is parallel with a light incidence surface and a light exit surface of the liquid crystal device 12 by half (½) of the pixel pitch in the horizontal direction. That is, as shown in a region hatched with slashes inclining down to the left of FIG. 7B, if an exposure is performed in this state, a further exposure will be performed in the position adjacent to the first exposure region in the horizontal direction on the photosensitive material 14, in which the first exposure region is a region hatched with slashes inclining down to the right. At the time of this second exposure, the driving device 14 supplies the image data corresponding to the second exposure region to each pixel of the liquid crystal equipment 12.

Similarly at the time of a third exposure, the movement control device 45 moves the liquid crystal device 12 by half (½) of the pixel pitch in the vertical direction in a plane which is parallel with the light incidence surface and the light exit surface of the liquid crystal device 12. If a further exposure is performed in this state, as shown by a region hatched with slashes inclining down to the left of FIG. 7C, this third exposure is performed on the photosensitive material 14 in the position below the exposure region of the second exposure among the exposure regions of the first and second exposures, which are hatched with slashes inclining down to the right. Furthermore, at the time of a fourth exposure, the movement control device 45 moves the liquid crystal device 12 in a plane which is parallel with the light incidence surface and the light exit surface of the liquid crystal device 12 by half (½) of the pixel pitch in a different horizontal direction. If an exposure is performed in this state, as shown by regions hatched with slashes inclining down to the left of FIG. 7D, the fourth exposure is performed on the photosensitive material 14 in the position below the exposure regions of the first exposure in the vertical direction among the exposure regions of the first to third exposures, which are hatched with slashes inclining down to the right of FIG. 7D.

In this way, four times of the number of pixels of the liquid crystal device 12 can be exposed by performing four times of division exposures by the pixel shifting. In this case, the exposure region at the time of each exposure is specified by the size of the opening region 35 of the liquid crystal device 12, thus it is possible to assist the exposure regions to not overlap each other in each exposure, and help the image quality to not deteriorate.

In this embodiment, since the opening of the liquid crystal device 12 is set as 1/M (M being an integer) of a pixel pitch, even when performing the division exposure using the pixel shifting method, it is possible to prevent the image quality from deteriorating while preventing the exposure regions at the time of every exposure to not overlap each other.

Although this embodiment shows an example in which each of the horizontal resolution magnification and the vertical resolution magnification, which is a ratio of a pixel pitch and the size of an opening region, it is clear that the resolution magnification may be three or more. Moreover, values of the horizontal resolution magnification and the vertical resolution magnification may be different from each other.

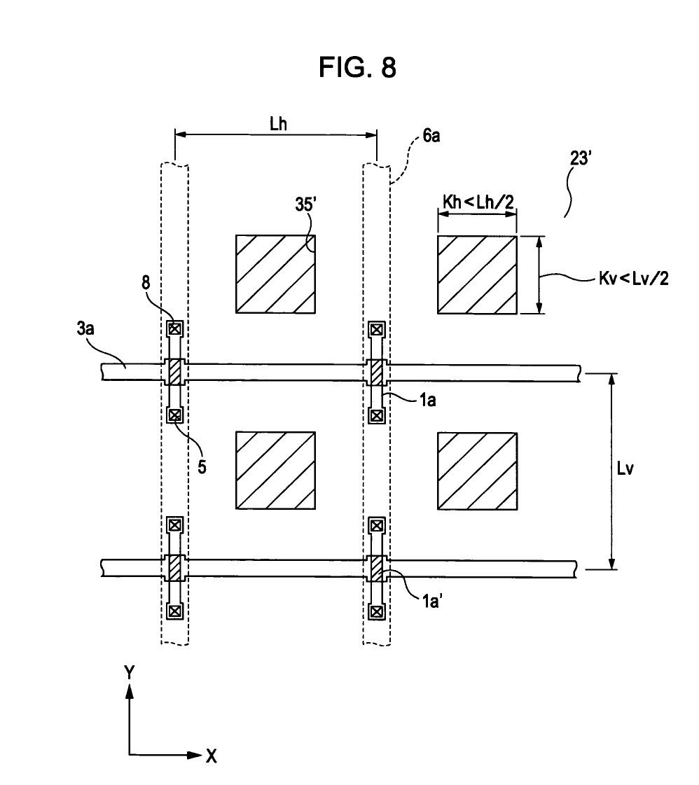

FIG. 8 is a plan view showing certain elements of the electro-optical device according to other embodiments. In FIGS. 1 and 8, like elements are referenced by like numerals, and for purposes of simplicity, explanation about the like elements is omitted.

The embodiments of FIG. 1 and FIG. 8 are different from each other in that the sizes of the opening regions are different. The embodiment of FIG. 1 relates to an example in which the optical system negligibly affects the exposure. However, the exposure regions on the photosensitive material by the exposures using the pixel shifting method may become slightly larger than regions calculated on the basis of the resolution magnification given by a ratio of the pixel pitch and the size of the opening region in each pixel due to the influence of the optical system. Accordingly, portions of the exposure regions of every exposure may overlap each other.

Taking the influence of the optical system into consideration, by decreasing the size of the opening region in each pixel it is possible to prevent the exposure regions by every exposure using the pixel shifting from overlaping each other.

Accordingly, in certain embodiments, the horizontal size Kh and the vertical size Kv of the opening region 35′ are slightly smaller than 1/M (M being an integer) of the horizontal pixel pitch Lh and the vertical pixel pitch Lv (½ in an example of FIG. 8), respectively. For example, in the case in which each of the horizontal pixel pitch and the vertical pixel pitch is 20.5 micrometers, the horizontal size Kh of the opening region 35′ is equal to the vertical size Kv of the opening 35′, and each of the horizontal size Kh and the vertical size Kv may be, for example, 8 micrometers. This figure is determined by considering the influence of the optical system and thus this figure changes if the optical systems differ.

In order to form the opening region 35′, the light shielding film 23′ is disposed in the liquid crystal device. That is, the liquid crystal device of this embodiment is different from the liquid crystal device of the embodiment in FIG. 1 in that the light shielding films 23 and 23′ are different from each other in the plane form.

In the exposure region on the photosensitive material, which corresponds to the pixel pitch of the liquid crystal device according to this embodiment, the ratio of the pixel pitch and the size of the opening of each pixel of the liquid crystal device may be slightly smaller than 1/M (M being an integer) of the pixel pitch by an amount which is calculated by considering the influence of the optical system in order to set the exposure region by each exposure using the pixel shifting to a size of 1/M (M is an integer).

Accordingly, as illustrated in FIG. 7, it is possible to improve resolution without deterioration of the image quality while preventing the exposure regions from overlapping each other when the exposure uses the pixel shifting method.

In this way, even when the optical system influences the exposure, it is possible to prevent the exposure regions from overlapping when the exposures use the pixel shifting method and to improve the image quality. In this manner, the size of the opening region is adjusted instead of adjusting the optical system which is difficult to control, and thus it is possible to achieve higher image quality by eliminating the influence of an optical system.

Moreover, in other embodiments, the electro-optical device can be applied to a different active matrix type liquid crystal panel (for example, a liquid crystal panel equipped with a thin film diode (TED) as a switching element) and a passive matrix type liquid crystal panel as well as a liquid crystal display panel equipped with a thin film transistor (TFT) as a switching element.

The preceding is merely a description of several embodiments. While specific embodiments and applications have been illustrated and described, it is to be understood that the precise configuration and components disclosed herein is illustrative only and not limiting in any sense. Having the benefit of this disclosure, various modifications, changes, and variations will be apparent to those of ordinary skill in the art without departing from the spirit and scope of the principles disclosed. Thus, to the maximum extent allowed by law, the scope of the invention is to be determined by the broadest permissible interpretation of the following claims and their equivalents, and shall not be restricted or limited by the foregoing description.

What is claimed is:

1. An electro-optical device comprising:
scan lines;
data lines;
pixels each having a pixel pitch and a light transmissible region, the pixels being arranged in a matrix form to correspond to intersections of the scan lines and the data lines, and the pixels being configured to change a transmissivity of light therethrough in response to one or more signals supplied from the scan lines and the data lines; and
a light shielding unit configured to restrict the light transmissible region of each of the pixels to a size of 1/M (M being an integer equal to or greater than 2) of the pixel pitch in each of a horizontal direction and a vertical direction for each of the pixels.

2. The electro-optical device according to claim 1, further comprising an opposite substrate facing the substrate, and wherein the light shielding unit comprises a light shielding film formed on at least one of the substrate and the opposite substrate.

3. A digital exposure apparatus configured to provide an exposure to an exposure region on a photosensitive material, the apparatus comprising the electro-optical device according to claim 1 and wherein the size of the restricted light transmissible region of each of the pixels of the electro-optical device is based upon a predetermined size of the exposure region.

4. An electro-optical device configured to convert light from a light source into an image light based on one or more image signals and expose the image light to exposure regions on a photosensitive material via an optical system, comprising:
scan lines;
data lines;
pixels each having a pixel pitch and a light transmissible region, the pixels being arranged in a matrix form to correspond to intersections of the scan lines and the data lines disposed on a substrate, and the pixels being configured to change a transmissivity of the light therethrough in response to the one or more image signals supplied via the scan lines and the data lines; and
a light shielding unit configured to restrict the light transmissible region of each of the pixels in both a horizontal direction and a vertical direction so that a size of each of the exposure regions on the photosensitive material irradiated with the image light is equal to a ratio of 1/M (M being an integer equal to or greater than 2) of the pixel pitch in the horizontal direction and the vertical direction for each of the pixels.

5. The electro-optical device according to claim 4 wherein the ratio is determined in accordance with characteristics of the optical system.

6. The electro-optical device according to claim 4, further comprising an opposite substrate facing the substrate, and wherein the light shielding unit comprises a light shielding film formed on at least one of the substrate and the opposite substrate.

7. The electro-optical device according to claim 4, wherein the optical system causes a predetermined spread of the image light; and wherein the light shielding unit is configured to restrict the light transmissible region of each of the pixels to a size smaller than the ratio of 1/M of the pixel pitch in the horizontal direction and the vertical direction for each of the pixels to compensate for the predetermined spread.

8. An electro-optical device configured to convert light from a light source into an image light based on one or more image signals, and which exposes the image light to exposure regions on a photosensitive material via an optical system, comprising:
scan lines;
data lines;
pixels each having a pixel pitch and a light transmissible region, the pixels being arranged in a matrix form to correspond to intersections of the scan lines and the data lines disposed on a substrate, and the pixels being configured to change a transmissivity of the light therethrough in response to the one or more image signals supplied via the scan lines and the data lines; and
a light shielding unit configured to restrict the light transmissible region of each of the pixels to a size of 1/L (L being an integer equal to or greater than 2) of the pixel pitch in each of a horizontal direction and a vertical direction for each of the pixels such that a horizontal size of each the exposure regions from the image light corresponds to 1/M (M being an integer equal to or greater than 2) of the pixel pitch and a vertical size of each of the exposure regions corresponds to 1/N (N being an integer equal to or greater than 2) of the pixel pitch.

9. A digital exposure apparatus comprising:
a light source configured to emit a light to provide an exposure to a photosensitive material; and
an electro-optical device including
a plurality of pixels each having a pixel pitch and a light transmissible region, the pixels being configured to permit the light to pass through the light transmissible region to the photosensitive material in response to one or more image signals supplied to the electro-optical device, and
a light shielding unit configured to restrict the light transmissible region of each of the pixels to a size of 1/M (M being an integer equal to or greater than 2) of the pixel pitch in each of a horizontal direction and a vertical direction for each of the pixels.

10. The apparatus of according to claim 9, further comprising:
an image processing device configured to perform image processing and provide an image data;
a driving device configured to receive the image data from the image processing device and to supply an image signal to the electro-optical device;
a movement control device configured to move the electro-optical device horizontally and vertically in a plane that is parallel with a surface of the electro-optical device to which the light is incident; and
an optical system configured to receive the light from the electro-optical device and direct the light to the photosensitive material.

11. The apparatus according to claim 9, wherein the electro-optical device further comprises a substrate and an opposite substrate facing the substrate, and wherein the light shielding unit comprises a light shielding film formed on at least one of the substrate and the opposite substrate.

12. The apparatus according to claim 9, wherein the size of the restricted light transmissible region of each of the pixels of the electro-optical device is based upon a predetermined size of an exposure region of the photosensitive material.
